(19) United States
(12) Patent Application Publication
(10) Pub. No.: US 2026/0094730 A1
(43) Pub. Date: Apr. 2, 2026

(54) METHODS OF HALOGENATING ACTINIDE OXIDE COMPOUNDS AND RELATED SYSTEMS

(71) Applicant: United States Department of Energy, Washington, DC (US)

(72) Inventors: Catherine L. Riddle, Idaho Falls, ID (US); Piyush Sabharwall, Idaho Falls, ID (US)

(21) Appl. No.: 18/900,692

(22) Filed: Sep. 28, 2024

(51) Int. Cl. G21C 3/60; B01J 8/08

(52) U.S. Cl. CPC G21C 3/60; B01J 8/085

(57) ABSTRACT

A method of halogenating actinide oxide compounds comprises reacting a feedstock comprising two or more actinide oxide compounds with a fluorination reactant or with a chlorination reactant to form fluorinated actinide intermediate compounds or chlorinated actinide intermediate compounds, respectively. The fluorinated actinide intermediate compounds or the chlorinated actinide intermediate compounds are oxidized to form actinide fluoride compounds or actinide chloride compounds, respectively. Additional methods and systems are also disclosed.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates generally to chemically halogenating actinide oxide compounds. More specifically, uranium oxides and plutonium oxides are chemically halogenated to produce uranium halides and plutonium halides.

### BACKGROUND

Recycling of used nuclear fuel minimizes the impact of nuclear power on the environment, establishes reactor safety through fuel recycling, and saves raw materials for production of nuclear fuel for Generation IV advanced reactors. This includes molten salt technologies (MST) that may be applied to fields such as nuclear reactors (molten salt reactors), propulsion, and fuel storage, creating a safe transition from used fuel to new MST fuel. One challenge of implementing various MST is related to the availability of a domestic supply of halide salts of uranium (U) and plutonium (Pu) to fabricate MST fuel.

### BRIEF SUMMARY

A method of halogenating actinide oxide compounds is disclosed and comprises reacting a feedstock comprising two or more actinide oxide compounds with a fluorination reactant or with a chlorination reactant to form fluorinated actinide intermediate compounds or chlorinated actinide intermediate compounds, respectively. The fluorinated actinide intermediate compounds or the chlorinated actinide intermediate compounds are oxidized to form actinide fluoride compounds or actinide chloride compounds, respectively.

A method of halogenating actinide oxide compounds is disclosed and comprises reacting a feedstock comprising uranium oxide and plutonium oxide with a fluorination reactant or with a chlorination reactant to form fluorinated uranium intermediate compounds and fluorinated plutonium intermediate compounds or chlorinated uranium intermediate compounds and chlorinated plutonium intermediate compounds, respectively. Fully fluorinated intermediate compounds of the fluorinated uranium intermediate compounds and the fluorinated plutonium intermediate compounds are separated from partially fluorinated intermediate compounds and non-fluorinated intermediate compounds of the fluorinated uranium intermediate compounds and the fluorinated plutonium intermediate compounds. Or, fully chlorinated intermediate compounds of the chlorinated uranium intermediate compounds and the chlorinated plutonium intermediate compounds are separated from partially chlorinated intermediate compounds and non-chlorinated intermediate compounds of the chlorinated uranium intermediate compounds and the chlorinated plutonium intermediate compounds. The fully fluorinated intermediate compounds or the fully chlorinated intermediate compounds are oxidized to form uranium fluoride compounds and plutonium fluoride compounds or uranium chloride compounds and plutonium chloride compounds. The uranium fluoride compounds and plutonium fluoride compounds or the uranium chloride compounds and the plutonium chloride compounds are recovered.

A system for halogenating actinide oxide compounds is disclosed and comprises a first reaction vessel configured to conduct a halogenation reaction of actinide oxide compounds. A first separator is coupled to the first reaction vessel and is configured to separate halogenated actinide intermediate compounds from the actinide oxide compounds. A second reaction vessel is coupled to the first separator and is configured to oxidize the halogenated actinide intermediate compounds to form halogenated actinide compounds. A second separator is coupled to the second reaction vessel and is configured to recover the halogenated actinide compounds.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a flowchart illustrating a method for halogenating actinide oxide compounds according to embodiments of the disclosure.

FIG. 2 is a flowchart illustrating a method for fluorinating U/Pu oxides according to embodiments of the disclosure.

FIG. 3 is a flowchart illustrating a method for chlorinating U/Pu oxides according to embodiments of the disclosure.

FIG. 4 is a process flow diagram illustrating a system for fluorinating U/Pu oxides according to embodiments of the disclosure.

FIG. 5 is a process flow diagram illustrating a system for chlorinating U/Pu oxides according to embodiments of the disclosure.

### DETAILED DESCRIPTION

The illustrations presented herein are not actual views of any process, or any step thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

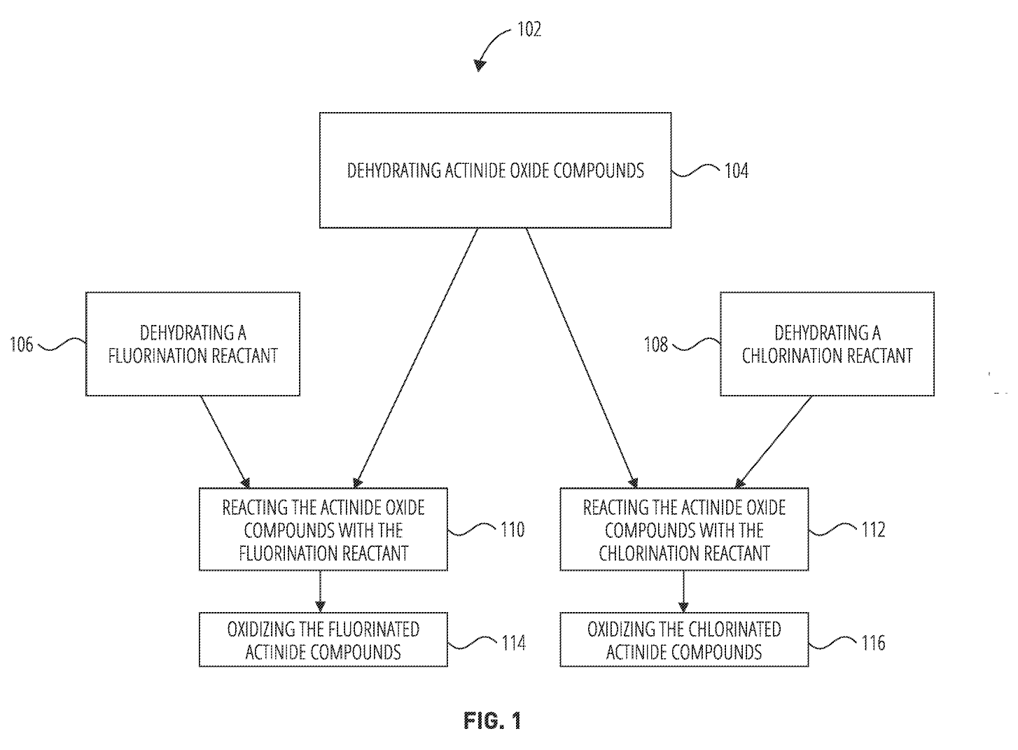

A chemical halogenation process is used to convert actinide oxide compounds to actinide salt compounds (e.g., actinide halide compounds) as shown in FIGS. 1-3. The actinide oxide compounds are components of an actinide oxide feedstock that includes two or more actinide oxide compounds. By way of example only, the actinide oxide feedstock may be obtained from used nuclear fuel, such as used nuclear fuel generated by a light water reactor (LWR), or a stored nuclear fuel. The used nuclear fuel generated by currently-operating LWRs and other reactors, as well as nuclear fuel stored in many locations across the United States and worldwide, may be used as an input (e.g., a feedstock) for the chemical halogenation process according to embodiments of the disclosure and the resulting actinide halide compounds used as a fuel for MSTs. By using the actinide oxide feedstock as a source material (e.g., the actinide oxide feedstock) in the chemical halogenation process according to embodiments of the disclosure, stockpiles of used nuclear fuel may be reduced.

The chemical halogenation process may, for example, include halogenating the actinide oxide compounds to form halogenated actinide intermediate compounds, followed by oxidizing the halogenated actinide intermediate compounds to form actinide halide compounds. To halogenate the actinide oxide compounds, a halogenation reactant is reacted with the actinide oxide compounds. The resulting halogenated actinide intermediate compounds may include, but are not limited to, fully halogenated actinide intermediate compounds and partially halogenated actinide intermediate compounds. The reaction may also form non-halogenated actinide intermediate compounds and other byproducts. The fully halogenated actinide intermediate compounds may be oxidized to form the actinide halide compounds by reacting the fully halogenated actinide intermediate compounds with an oxygen source compound or a halogenated carbon compound. The actinide halide compounds may be recovered following the oxidation reaction. A ratio of the two or more actinide oxide compounds in the actinide oxide feedstockmay substantially correspond to a ratio of the actinide halide compounds to be produced by the chemical halogenation process, which enables the composition of the actinide halide compounds to be tailored by appropriately selecting the actinide oxide feedstock.

The chemical halogenation process according to embodiments of the disclosure may achieve a desired oxidation state purity and stoichiometry of the actinide halide compounds. For instance, uranium oxide (UO₂) and plutonium oxide (PuO₂) in a uranium oxide/plutonium oxide feedstock may be subjected to the chemical halogenation process to form uranium halide compounds and plutonium halide compounds. For convenience, the UO₂ and PuO₂ may be collectively referred to herein as U/Pu oxides, the UO₂ and PuO₂ in the feedstock may be referred to herein as a U/Pu oxide feedstock, and reaction products of the chemical halogenation process may be referred to as actinide halide compounds (e.g., uranium halide compounds and plutonium halide compounds). Byproducts of the halogenation reaction and the oxidation reaction may be reused in the chemical halogenation process, increasing the efficiency of forming the actinide halide compounds. The uranium halide compounds and plutonium halide compounds are recovered and may be used as a fuel in a molten salt reactor (MSR) or other molten salt technology (MST).

FIG. 1 is a flowchart of a method 102 for halogenating actinide oxide compounds. The method optionally includes dehydrating the actinide oxide feedstock (e.g., the U/Pu oxide feedstock) prior to conducting the halogenation reaction. The actinide oxide feedstock may provide an initial source of the two or more actinide oxide compounds to be halogenated. If the actinide oxide feedstock includes more than a minimal amount of water, the water may be removed before reacting the actinide oxide compounds with the halogenation reactant. The method 102 includes dehydrating the actinide oxide compounds 104 to obtain a substantially dry actinide oxide feedstock. If, however, the actinide oxide feedstock includes a minimal amount of water, dehydrating the actinide oxide feedstock may be optional. The actinide oxide feedstock may be reacted with the halogenation reactant to form the halogenated actinide intermediate compounds (e.g., the fluorinated actinide compounds, the chlorinated actinide compounds). The halogenation reactant may include the fluorination reactant or the chlorination reactant. The halogenation reaction results in fluorinating the actinide oxide compounds 110 or chlorinating the actinide oxide compounds 112, depending on the halogenation reactant used. Oxidizing the fluorinated actinide compounds 114 or oxidizing the chlorinated actinide compounds 116 produces the actinide halide compounds. A ratio of the actinide oxide compounds in the actinide oxide feedstockmay substantially correspond to a ratio of the actinide halide compounds produced by the chemical halogenation process. By selecting the actinide oxide feedstock to include specific relative amounts of the two or more actinide oxide compounds, the actinide halide compounds may be produced at a desired ratio that substantially corresponds to the ratio in the actinide oxide feedstock. The resulting actinide halide compounds at the desired ratio may be used in an MSR or other MST.

The actinide oxide feedstock may be obtained from an actinide oxide source material by a variety of conventional processes including, but not limited to, a co-decontamination (CoDECon) process or a reduction oxidation of actinides (ROANEX) process. The CoDECon process and the ROANEX process are known in the art and are not described in detail herein. However, other processes for obtaining the actinide oxide feedstock from the actinide oxide source material may be used. The actinide oxide feedstock used in method 102 may be substantially free from other actinides (e.g., neptunium, americium, curium, technetium, other minor actinides) as well as being substantially free from fission products and activation products. If, however, the actinide oxide feedstock includes large amounts of the other actinides, the fission products, or the activation products, these components may be removed from the actinide oxide compounds before conducting the chemical halogenation process on a relatively pure feedstock containing the actinide oxide compounds. By way of example only, the CoDECon process or the ROANEX process may be used to remove these components. Substantially pure solids (e.g., precipitates) of the actinide oxide compounds may be obtained following the CoDECon process or the ROANEX process and used in the chemical halogenation process according to embodiments of the disclosure. By way of nonlimiting example, the actinide oxide compounds may exhibit a purity ranging from about 95 weight percent (wt%) to about 99.999 wt%.

The actinide oxide feedstock (e.g., the U/Pu oxide feedstock) may include, but is not limited to, a combination of uranium dioxide (UO₂) and plutonium dioxide (PuO₂). The U/Pu oxide feedstock may also include a high oxide solids content. However, a feedstock containing other actinide oxide compounds may be used. The U/Pu oxide feedstock may include the UO₂ and PuO₂ at differing relative amounts depending on the source material of the UO₂ and PuO₂ and on the intended use for the resulting uranium halide compounds and plutonium halide compounds. For example, a ratio of the UO₂ to the PuO₂ (UO₂:PuO₂) in the U/Pu oxide feedstock may substantially correspond to a ratio of uranium halide compounds and plutonium halide compounds to be produced by the chemical halogenation process. The UO₂:PuO₂ in the U/Pu oxide feedstock may, for example, range from about 20:80 to about 80:20, such as from about 25:75 to about 75:25 or from about 30:70 to about 70:30. The U/Pu oxide feedstock may be obtained from a used nuclear fuel stockpile, or from product streams of the CoDECon process or of the ROANEX process. The U/Pu oxide feedstock may also include partially halogenated U/Pu compounds and/or non-halogenated U/Pu compounds produced as byproducts of the chemical halogenation process, enabling these compounds to be reused in the chemical halogenation process. In some embodiments, the UO₂:PuO₂ in the U/Pu oxide feedstock is 70:30, which reduces issues with non-proliferation regulations and enables the resulting uranium halide compounds and plutonium halide compounds to be used with existing molten salt systems. For instance, the actinide halide compounds may be used in an MSR or other MST.

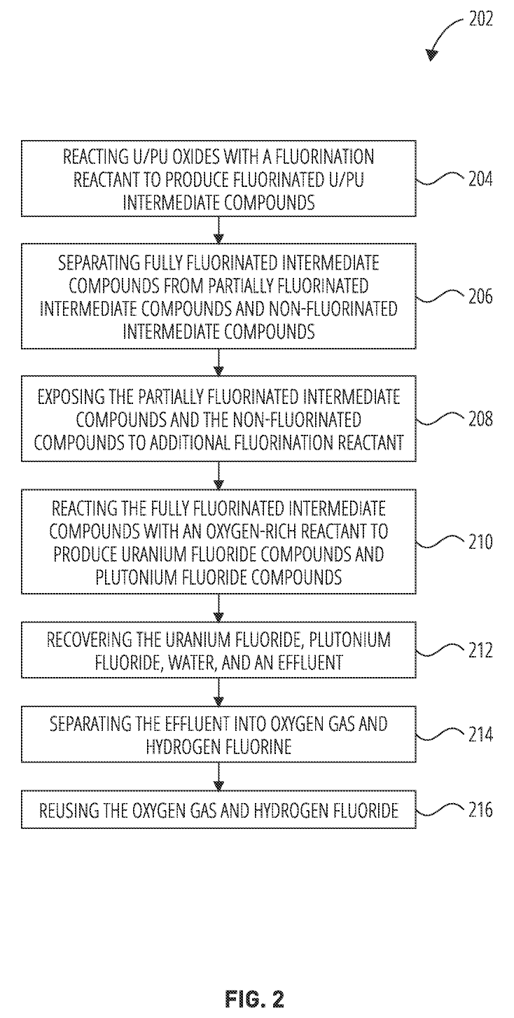

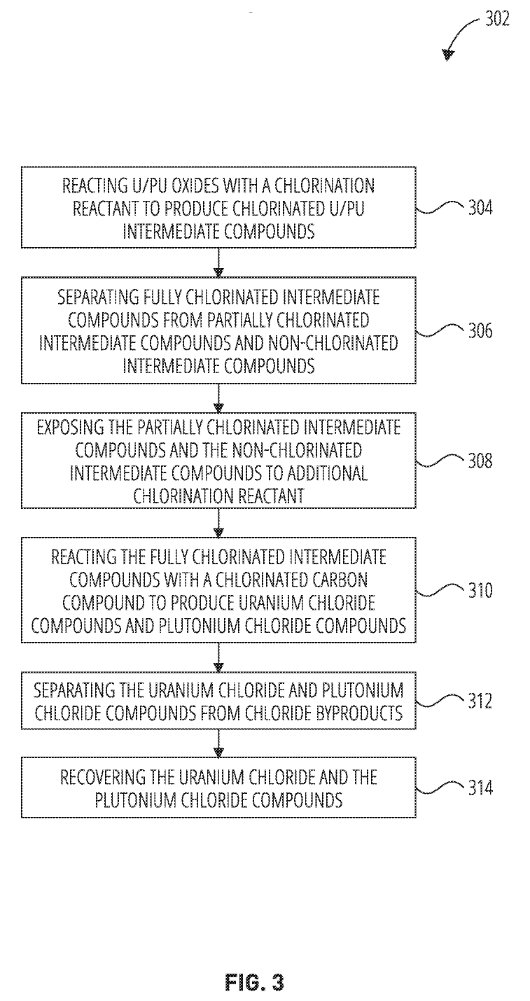

The actinide oxide feedstock (e.g., the U/Pu oxide feedstock) may be subjected to the chemical halogenation process, which includes fluorinating the actinide oxide compounds 110 of the actinide oxide feedstock, as described in FIG. 2, or chlorinating the actinide oxide compounds 112 of the actinide oxide feedstock, as described in FIG. 3. However, the chemical halogenation process may be conducted using other halogens such as bromine (Br) or iodine (I). In addition, actinide oxide compounds other than UO₂ and PuO₂ may be subjected to the chemical halogenation process. The actinide oxide compounds are reacted with the fluorination reactant or with the chlorination reactant and oxidized to produce the actinide fluoride compounds or the actinide chloride compounds, respectively.

The fluorination process and the chlorination process may be conducted on the U/Pu oxide compounds in a single system. Alternatively, the fluorination process or the chlorination process may be separately conducted on the U/Pu oxide compounds.

The halogenation reactant is used in the chemical halogenation process to form the halogenated actinide intermediate compounds from the actinide oxide compounds. The halogenation reactant may include, but is not limited to, the fluorination reactant or the chlorination reactant. Nonlimiting examples of the fluorination reactant include ammonium bifluoride (NH₄HF₂), gaseous hydrogen fluoride (HF), sodium fluoride (NaF), an organic fluoride compound, or a combination thereof. Nonlimiting examples of the chlorination reactant include chlorine gas (Cl₂), which functions as a chloride source. Hydrochloric acid (HCl) may also function as a chloride source. The halogenation reactant may optionally be dehydrated before use by dehydrating the fluorination reactant 106 or dehydrating the chlorination reactant 108 to reduce or substantially eliminate condensation reactions during the chemical halogenation process. The dehydration of the halogenation reactant may be accomplished using an anhydrous solvent or a drying agent to absorb any water and obtain a substantially anhydrous (e.g., dry) halogenation reactant. By way of example only, an inert gas, such as helium (He), may be used to reduce the water content in the halogenation reactant. The inert gas may also reduce or substantially eliminate safety hazards during the chemical halogenation process. A substantially anhydrous halogenation reactant may include less than about 10% water, such as from about 1% to less than about 10% water.

FIG. 2 is a flowchart of a method 202 for fluorinating U/Pu oxides to form U/Pu fluoride compounds. The U/Pu oxides in the U/Pu oxide feedstock are fluorinated by reacting the fluorination reactant with the U/Pu oxides (act 204) to form fluorinated U/Pu intermediate compounds. The fluorination reactant and the U/Pu oxides may be substantially anhydrous (e.g., substantially free of water). If hydrogen fluoride is used as the fluorination reactant, an inert gas, such as helium (He₂), may be present to reduce or eliminate safety hazards. The fluorination reactant and the U/Pu oxide feedstock may be combined in a vessel (e.g., a reaction vessel) to conduct the fluorination reaction. The fluorination reaction may produce one or more fully fluorinated intermediate compounds, partially fluorinated intermediate compounds, and non-fluorinated intermediate compounds, such as fully fluorinated U/Pu intermediate compounds, partially fluorinated U/Pu intermediate compounds, and non-fluorinated U/Pu intermediate compounds. Additional byproducts of the fluorination reaction may also be produced.

A stoichiometric amount or an excess of the fluorination reactant may be used in the fluorination reaction relative to the amount of UO₂ and PuO₂, depending on the oxidation state of the U atoms or Pu atoms. By way of nonlimiting example, the respective U atoms or Pu atoms may bond with between three fluoride atoms and six fluoride atoms depending on the respective oxidation state of the U atoms or Pu atoms. The oxidation state for the U atoms or Pu atoms may remain the same during the fluorination reaction or may change. By way of non-limiting example, the oxidation number for the U atoms may change from +6 to +4 and the oxidation number for the Pu atoms may change from +6 to +4. Reacting the U/Pu oxide compounds with the fluorination reactant produces the fluorinated U/Pu intermediate compounds that may include one or more of the fully fluorinated U/Pu intermediate compounds, the partially fluorinated U/Pu intermediate compounds, or the non-fluorinated U/Pu intermediate compounds. During the fluorination reaction, the relative amounts of U and Pu are maintained at a substantially similar U:Pu ratio as was present in the U/Pu oxide feedstock.

The fluorination of the UO₂ and PuO₂ in act 204 may be conducted at ambient temperature and ambient pressure to reduce or substantially eliminate safety hazards. By way of example only, the fluorination reaction may be conducted at a temperature of from about 0℃ to about 30℃, such as from about 20℃ to about 30℃, and a pressure of from about 12 psi to about 20 psi. Flow rate, and other process parameters may be selected to provide efficient fluorination of the UO₂ and PuO₂.

The fully fluorinated U/Pu intermediate compounds of the fluorinated U/Pu intermediate compounds may be separated from the partially fluorinated U/Pu intermediate compounds and the non-fluorinated U/Pu intermediate compounds as shown in act 206. The fully fluorinated U/Pu intermediate compounds may be separated by conventional techniques. By way of example only, the fully fluorinated U/Pu intermediate compounds may be separated using a condensation, a distillation, an extraction, or other separation technique. Additional byproducts may be present in the fully fluorinated U/Pu intermediate compounds and in the partially fluorinated U/Pu intermediate compounds and the non-fluorinated U/Pu intermediate compounds. Separating the fully fluorinated intermediate compounds in act 206 may be conducted at ambient temperature and ambient pressure to reduce or substantially eliminate safety hazards. By way of example only, the act 206 may be conducted at a temperature of from about 0℃ to about 30℃, such as from about 20℃ to about 30℃, and a pressure of from about 10psi to about 20 psi. Flow rate, and other process parameters may be selected to provide efficient separation of the compounds.

After the separation act 206, the partially fluorinated U/Pu intermediate compounds and the non-fluorinated U/Pu intermediate compounds may be exposed to an additional amount of the fluorination reactant. Exposing the partially fluorinated U/Pu intermediate compounds and the non-fluorinated U/Pu intermediate compounds in act 208 to the fluorination reactant forms an additional amount of the fully fluorinated U/Pu intermediate compounds. The partially fluorinated U/Pu intermediate compounds and the non-fluorinated U/Pu compounds may, therefore, be used as reactants in other acts of the method 202. By recovering the partially fluorinated U/Pu intermediate compounds and the non-fluorinated U/Pu compounds and subjecting the partially fluorinated U/Pu intermediate compounds and the non-fluorinated U/Pu compounds to the fluorination conditions, any partially fluorinated or non-fluorinated U/Pu intermediate compounds may become fully fluorinated, which improves the overall yield of the method 202.

The fully fluorinated U/Pu intermediate compounds from the separation act 206 may be oxidized to form U/Pu fluoride compounds (e.g., uranium fluoride compounds and plutonium fluoride compounds). An oxygen-rich reactant may be introduced to the vessel and reacted with the fully fluorinated U/Pu intermediate compounds to substantially complete the fluorination reaction and help with decomposition in act 210. Nonlimiting examples of the oxygen-rich reactant may include oxygen (O₂) or an alcohol such as methanol or ethanol. The O₂ may be commercially available or may be obtained as a product stream from an industrial process. By way of example only, the O₂ may be obtained from the electrolysis of water (H₂O), from an O₂ capture process, or from an O₂ sequestration process. Heat may also be provided during the introduction of the oxygen-rich reactant to ensure the fluorination reaction proceeds to substantial completion. The substantially complete fluorination of the fully fluorinated U/Pu compounds in act 210 produces uranium fluoride compounds and plutonium fluoride compounds, such as uranium fluoride (UF₄) and plutonium fluoride (PuF_{3,} PuF₄). Water and an O₂/HF effluent may also be produced. The uranium fluoride compounds and plutonium fluoride compounds are present at a substantially similar U:Pu ratio as was present in the U/Pu oxide feedstock. The relative amounts of the uranium fluoride compounds and the plutonium fluoride compounds produced may be substantially similar to the relative amounts of UO₂ and PuO₂ present in the U/Pu oxide feedstock. The uranium fluoride and plutonium fluoride may be substantially pure since the U/Pu oxides were of a high purity. By way of nonlimiting example, the substantially pure uranium fluoride and plutonium fluoride may be from about 95% pure to about 99.999% pure.

The oxidation may be conducted at a temperature range of from about 50°C to about 160°C. Pressure, flow rate, and other process parameters may be selected to provide substantially complete and efficient fluorination of the UO₂ and PuO₂.

The uranium fluoride compounds, plutonium fluoride compounds, water, and the O₂/HF effluent may be recovered in act 212. For instance, the uranium fluoride compounds and the plutonium fluoride compounds may be recovered and the water and O₂/HF effluent may be separately recovered. The O₂/HF effluent may include varying amounts of oxygen and HF resulting from the chemical reactions in acts 204, 210. The O₂/HF effluent may be separated, by conventional techniques, into O₂ and HF in act 214. By way of example only, the O₂/HF effluent may be separated using a condensation, a distillation, an extraction, or other separation technique. The separation of O₂ and HF in act 214 may be conducted at ambient temperature and ambient pressure to reduce or substantially eliminate safety hazards. By way of example only, the separation may be conducted at a temperature of from about 0℃ to about 30℃, such as from about 20℃ to about 30℃, and a pressure of from about 10 psi to about 20 psi. Flow rate, and other process parameters may be selected to provide efficient separation of the O₂ and HF.

The separated O₂ and HF may be reused as reactants in act 216. The separated O₂ and HF may then be reused, such as in the method 202. The recovered O₂ may, for example, be used in act 210 as the oxygen-rich reactant and the HF may be used in act 204 as the fluorination reactant.

FIG. 3 is a flowchart of a method 302 for chlorinating U/Pu oxides to form U/Pu chloride compounds. The U/Pu oxides in the U/Pu oxide feedstock (e.g., UO₂ and PuO₂) are chlorinated by reacting the chlorination reactant with the U/Pu oxides (act 304). In the chlorination reaction, the UO₂ and PuO₂ may optionally be reacted with hydrochloric acid (HCl) in addition to the chlorination reactant. The chlorination reactant may include chlorine gas (Cl₂), which functions as a chloride source. The HCl, when present, may also function as a chloride source. The chlorination reactant and the U/Pu oxides may be substantially anhydrous (e.g., substantially free of water). The chlorination reactant and the U/Pu oxide feedstock may be combined in a vessel (e.g., a reaction vessel) to conduct the chlorination reaction. The chlorination reaction may produce one or more fully chlorinated intermediate compounds, partially chlorinated intermediate compounds, and non-chlorinated intermediate compounds, such as fully chlorinated U/Pu intermediate compounds, partially chlorinated U/Pu intermediate compounds, and non-chlorinated U/Pu intermediate compounds. Additional byproducts of the chlorinated reaction may also be produced, such as tetrachloroethylene, hexachloroethane, hydrogen chloride, phosgene, cis-1,2-dichloroethene, or a combination thereof.

A stoichiometric amount or an excess of the chlorination reactant to the UO₂ and PuO₂ may be used in the chlorination reaction, depending on the oxidation state of the U atoms or Pu atoms used in the chlorination reaction. By way of nonlimiting example, U atoms or Pu atoms may bond with three chloride atoms or four chloride atoms depending on the respective oxidation state for the U atoms or Pu atoms. The oxidation state for the U atoms or Pu atoms may remain the same during the chlorination reaction or may change. By way of non-limiting example, the oxidation state for the U atoms may change from +6 to +4, and the oxidation state for the Pu atoms may change from +6 to +4. During the chlorination reaction, the UO₂ and PuO₂ are chlorinated to produce chlorinated U/Pu intermediate compounds that may include one or more of the fully chlorinated U/Pu intermediate compounds, the partially chlorinated U/Pu intermediate compounds, and the non-chlorinated U/Pu intermediate compounds. The chlorinated U/Pu intermediate compounds may include, but are not limited to, UCl₂ and PuCl₂, and the relative amounts of U and Pu may be maintained at a substantially similar U:Pu ratio as was present in the U/Pu oxide feedstock.

The chlorination reaction of the UO₂ and PuO₂ in act 304 may be conducted at ambient temperature and ambient pressure to reduce or substantially eliminate safety hazards. By way of example only, the chlorination reaction may be conducted at a temperature of from about 0℃ to about 30℃, such as from about 20℃ to about 30℃, and at a pressure of from about 10 psi to about 20 psi. Flow rate, and other process parameters may be selected to provide efficient chlorination of the UO₂ and PuO₂.

The fully chlorinated U/Pu intermediate compounds from act 304 may be separated from the partially chlorinated intermediate U/Pu compounds and the non-chlorinated intermediate compounds in act 306. The fully chlorinated intermediate compounds may be separated by conventional techniques. By way of example only, the fully chlorinated U/Pu intermediate compounds may be separated using a condensation, a distillation, an extraction, or other separation technique. Additional byproducts may be present in the fully chlorinated U/Pu intermediate compounds and in the partially chlorinated U/Pu intermediate compounds and the non-chlorinated U/Pu intermediate compounds. Separating the fully chlorinated U/Pu intermediate compounds may be conducted at ambient temperature and ambient pressure to reduce or substantially eliminate safety hazards. By way of example only, the act 306 may be conducted at a temperature of from about 0℃ to about 30℃, such as from about 20℃ to about 30℃ and a pressure of from about 10 psi to about 20 psi. Flow rate, and other process parameters may be selected to provide efficient separation of the fully chlorinated intermediate compounds from the partially chlorinated intermediate compounds and non-chlorinated intermediate compounds.

After the separation act 306, the partially chlorinated U/Pu intermediate compounds and the non-chlorinated U/Pu intermediate compounds may be exposed to an additional amount of the chlorination reactant. Exposing the partially chlorinated U/Pu intermediate compounds and the non-chlorinated U/Pu intermediate compounds in act 308 to the chlorination reactant forms an additional amount of the fully chlorinated U/Pu intermediate compounds. By recovering the partially chlorinated U/Pu intermediate compounds and the non-chlorinated U/Pu intermediate compounds and subjecting the partially chlorinated U/Pu intermediate compounds and the non-chlorinated U/Pu compounds to the chlorination conditions, the partially chlorinated or non-chlorinated U/Pu intermediate compounds may be fully chlorinated, improving the overall yield of the method 302.

A chlorinated carbon compound may be reacted with the fully chlorinated U/Pu intermediate compounds from the chlorination reaction in act 310 to form uranium chloride compounds and plutonium chloride compounds. Small amounts of byproducts (e.g., chloride byproducts) may also be produced. The chlorinated carbon compound may be used to oxidize the fully chlorinated U/Pu intermediate compounds, facilitating the release of the oxygen atoms of the UO₂ and PuO₂ and changing the oxidation states of the U and Pu. The chlorinated carbon compound may also function as a chloride source. Nonlimiting examples of the chlorinated carbon compound include, but are not limited to, carbon tetrachloride (CCl₄), trichloromethane (CHCl₃), tetrachloroethene (C₂Cl₄), a chlorinated alcohol, vinyl chloride, as well as other organic chloride compounds. By using the chlorinated carbon compound as a source of chlorine, uranium and plutonium in the UO₂ and PuO₂ may be oxidized. The fully chlorinated U/Pu intermediate compounds (e.g., UCl₂ and PuCl₂) are reacted with the chlorinated carbon compound to produce the uranium chloride compounds and plutonium chloride compounds, for example, UCl₃ and PuCl₃. The relative amounts of UCl₃ and PuCl₃ produced may be substantially similar to the relative amounts of UO₂ and PuO₂ present in the U/Pu oxide feedstock. The UCl₃ and PuCl₃ may be substantially pure since the U/Pu oxides used as reactants in the chlorination reaction are of a high purity. By way of nonlimiting example, the substantially pure uranium chloride and plutonium chloride may be from about 95% pure to about 99.999% pure.

The oxidation of the fully chlorinated U/Pu intermediate compounds in act 310 may be conducted at ambient temperature and ambient pressure to reduce or substantially eliminate safety hazards. By way of example only, act 310 may be conducted at a temperature of from about 0℃ to about 30℃, such as from about 20℃ to about 30℃, and a pressure of from about 10 psi to about 20 psi. Flow rate, and other process parameters may be selected to provide efficient oxidation of the fully chlorinated U/Pu intermediate compounds. The temperature, pressure, flow rate, and other process parameters may be selected to provide efficient to provide efficient oxidation of the UO₂ and PuO₂.

The reaction products from oxidation act 310 are separated into the byproducts (e.g., chloride byproducts) and the uranium chloride compounds and plutonium chloride compounds (e.g., UCl₃ and PuCl₃) in act 312. The chloride byproducts may include, but are not limited to, tetrachloroethylene, hexachloroethane, hydrogen chloride, phosgene, cis-1,2-dichloroethene, or a combination thereof. Separating the uranium chloride compounds and plutonium chloride compounds from the byproducts may be conducted by conventional techniques, such as a condensation, a distillation, an extraction, or other separation technique. After conducting the separation, the resulting uranium chloride compounds and plutonium chloride compounds may be recovered in act 314. Depending on the composition of the chloride byproducts, the chloride byproducts may be reused as reactants in the chlorination reaction or in the oxidation reaction. The separation act 312 may be conducted at ambient temperature and ambient pressure to reduce or substantially eliminate safety hazards. By way of example only, separation act 312 may be conducted at a temperature of from about 0℃ to about 30℃, such as from about 20℃ to about 30℃, and a pressure of from about 10 psi to about 20 psi. Flowrate, and other process parameters may be selected to provide efficient separation.

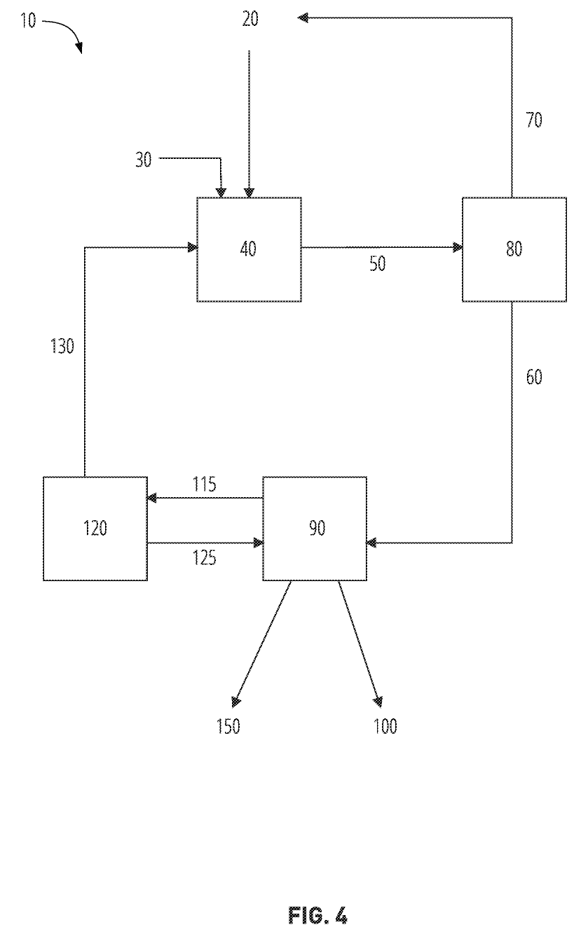

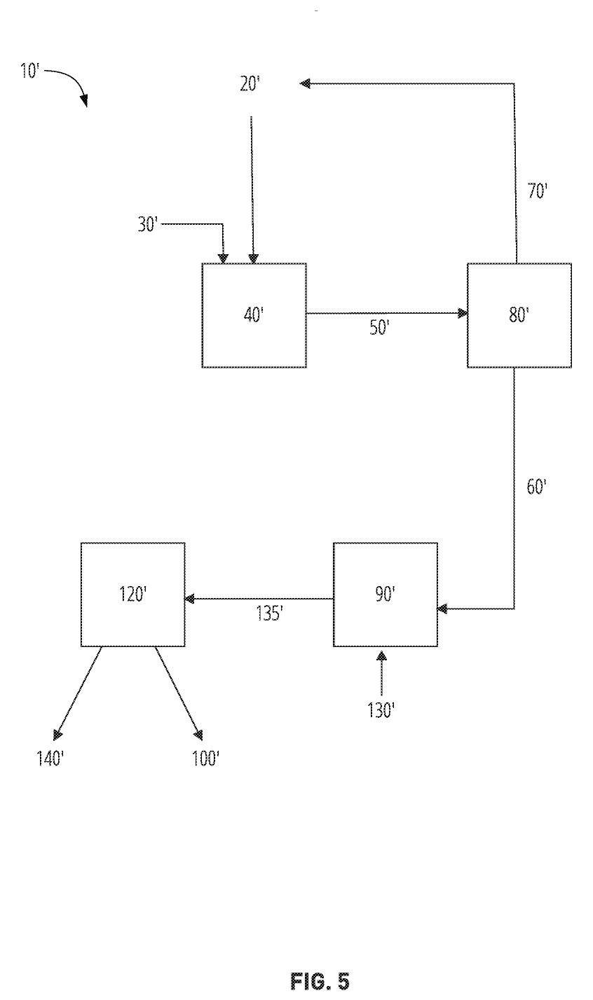

The chemical halogenation process may be conducted in system 10, 10ʹ that includes one or more reaction vessels, one or more contactors, one or more condensers, one or more separators, or other components as shown in FIGS. 4 and 5. The components may function independently or be connected in series. The reaction vessel may include, but is not limited to, a thermal reactor or a fast reactor. By way of example, the reaction vessel may be used for the chlorination and fluorination reactions, the contactor may be used for dehydration of the reactants, as well as for conducting the CoDECon process or the ROANEX process, and condensers may be used for the different separations. The components may be made of plastic, fibrous, glass, metal, or other materials compatible with the reactants used in the chemical halogenation process. The components may be formed of, for example, a metal that is capable of sustaining damage from the highly corrosive chemicals that are used in the chemical halogenation process. The metal may include, but is not limited to, stainless steel.

The chemical halogenation process according to embodiments of the disclosure may be conducted in a closed-loop system 10, 10ʹ where the process acts occur in series. In addition, intermediate reaction products do not need to be removed from the system 10, 10ʹ and introduced into a separate secondary system. Different systems 10, 10ʹ for conducting methods 102, 202, 302 may be coupled to each other. In addition, systems for conducting the ROANEX process or the CoDECon process may be coupled to the system 10, 10ʹ for conducting the chemical halogenation process. By way of example only, a system for conducting the ROANEX process may be coupled to the system 10, 10ʹ such that the U/Pu oxide compounds in the U/Pu oxide feedstock are fed into the fluorination process or the chlorination process without leaving the system 10, 10ʹ.

FIG. 4 is a process diagram showing a system 10 for conducting the chemical halogenation process according to embodiments of the disclosure. While the system 10 in FIG. 4 is described for use with uranium oxide compounds and plutonium oxide compounds, other actinide oxide compounds may be used. A UO₂/PuO₂ feedstock 20 is subjected to the fluorination process by introducing the UO₂/PuO₂ feedstock 20 and a fluorination reactant 30 to a reaction vessel 40 and combining the feedstock 20 and the fluorination reactant 30 in the reaction vessel. The fluorination process produces fluorinated U/Pu intermediate compounds 50, which may include fully fluorinated U/Pu intermediate compounds, partially fluorinated U/Pu intermediate compounds, and non-fluorinated U/Pu intermediate compounds. The fluorinated U/Pu intermediate compounds 50 are subjected to a separation process to form a U/Pu product stream 60 containing the fully fluorinated intermediate compounds and a U/Pu byproducts stream 70 containing the partially fluorinated U/Pu intermediate compounds and the non-fluorinated U/Pu intermediate compounds. The separation is conducted in a separator 80. The U/Pu byproducts stream 70 may be reused by directing the byproducts stream 70 to be combined with the UO₂/PuO₂ feedstock 20, which are then subjected to the fluorination process. The U/Pu product stream 60 is introduced to a reaction vessel 90 along with O₂ stream 125, which oxidizes the fully fluorinated U/Pu intermediate compounds. Alternatively, the O₂ stream is introduced to the reaction vessel 90 from an O₂ supply (not shown). The U/Pu product stream 60 and O₂ stream 125 are introduced to the reaction vessel 90 and combined. Heat may be applied to the U/Pu product stream 60 and O₂ stream 125 to complete fluorination and obtain a fully fluorinated product stream 100 that includes uranium fluoride and plutonium fluoride (e.g., UF₄/PuF₃), along with a water stream 150 and an O₂/HF effluent stream 115. The uranium fluoride and plutonium fluoride and water are recovered and exit the reaction vessel 90, while the O₂/HF effluent stream 115 is subjected to an effluent separation process in a separator 120. The effluent separation process produces two streams, an O₂ stream 125 and an HF stream 130. The O₂ stream 125 and the HF stream 130 may be reused in other portions of the system 10. For instance, the O₂ stream 125 may be used in the reaction vessel 90 as an oxygen-rich reactant, and the HF stream 130 may be used in the reaction vessel 40 as a fluorination reactant.

FIG. 5 is a process diagram showing a system 10ʹ for conducting the chemical halogenation process according to embodiments of the disclosure. While the system 10ʹ in FIG. 5 is described for use with uranium oxide compounds and plutonium oxide compounds, other actinide oxide compounds may be used. A UO₂/PuO₂ feedstock 20ʹ is subjected to the chlorination process by introducing the feedstock 20ʹ and a chlorination reactant 30ʹ to a reaction vessel 40ʹ and combining the feedstock 20ʹ and chlorination reactant 30ʹ. The chlorination process produces chlorinated U/Pu intermediate compounds 50ʹ, which may include fully chlorinated U/Pu intermediate compounds, partially chlorinated U/Pu intermediate compounds, and non-chlorinated U/Pu intermediate compounds. The chlorinated intermediate compounds 50ʹ are subjected to a separation process to form a U/Pu product stream 60ʹ containing the fully chlorinated U/Pu intermediate compounds and a byproducts stream 70ʹ containing the partially chlorinated U/Pu intermediate compounds and the non-chlorinated U/Pu intermediate compounds. The separation is conducted in a separator 80ʹ. The U/Pu byproducts stream 70ʹ may be reused by combining the U/Pu byproducts stream 70ʹ with the UO₂/PuO₂ feedstock 20ʹ, which are then subjected to the chlorination process. The product stream 60ʹ is introduced to a reaction vessel 90ʹ along with a chlorinated carbon compound 130ʹ, which reacts with and oxidizes the fully chlorinated U/Pu intermediate compounds to form fully chlorinated U/Pu product stream 135ʹ. The product stream 60ʹ and the chlorinated carbon compound 130ʹ are introduced to the reaction vessel 90ʹ and combined. The fully chlorinated U/Pu product stream 135ʹ may include uranium chloride and plutonium chloride, along with chloride byproducts. The fully chlorinated product stream 135ʹ is then subjected to a separation process in separator 120ʹ, which creates two streams, a uranium chloride and plutonium chloride product stream (e.g., UCl₃/PuCl₃) 100ʹ and a chloride byproducts stream 140ʹ. The uranium chloride and plutonium chloride products stream 100ʹ and the chloride byproducts stream 140ʹ are recovered and exit the impurity separation process.

While FIGS. 4 and 5 illustrate the fluorination and chlorination processes as being conducted in separate systems 10, 10ʹ, the fluorination and chlorination processes may be conducted in a single system 10. In addition, the chemical halogenation process may be conducted as a continuous process, increasing the efficiency of the fluorination and chlorination processes.

The recovered actinide halide compounds (e.g., UF₄/PuF₃, UCl₃/PuCl₃) may be used in a variety of MST technologies, such as energy storage (e.g., MSRs, advanced high temperature reactors (AHTRs)), nuclear electric propulsion, or extra-terrestrial surface power. The actinide fluoride compounds produced by the method 202 or the actinide chloride compounds produced by the method 302 may be compatible with a multitude of molten salts that act as primary coolants in MST technologies. Nonlimiting examples of the molten salts include lithium fluoride-beryllium fluoride (FLiBe) or lithium fluoride-sodium fluoride-potassium fluoride (FLiNaK).

Using the chemical halogenation process according to embodiments of the disclosure to form the actinide halide compounds from the actinide oxide compounds may increase the purity of the actinide halide compounds, as well as reduce hazards, process time, and cost compared to conventional techniques of forming actinide halide compounds. The chemical halogenation process also provides a domestic supply of the actinide halide compounds, which reduces reliance on foreign supplies. By using the actinide oxide feedstock in the chemical halogenation process according to embodiments of the disclosure, current stockpiles of used nuclear fuel may be reduced.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method of halogenating actinide oxide compounds, the method comprising:
reacting a feedstock comprising two or more actinide oxide compounds with a fluorination reactant or with a chlorination reactant to form fluorinated actinide intermediate compounds or chlorinated actinide intermediate compounds, respectively; and
oxidizing the fluorinated actinide intermediate compounds or the chlorinated actinide intermediate compounds to form actinide fluoride compounds or actinide chloride compounds, respectively.

2. The method of claim 1, wherein reacting the feedstock comprising two or more actinide oxide compounds comprises reacting the feedstock comprising uranium dioxide (UO₂) and plutonium dioxide (PuO₂) with the fluorination reactant or with the chlorination reactant.

3. The method of claim 2, wherein reacting the feedstock comprising uranium dioxide (UO₂) and plutonium dioxide (PuO₂) with the fluorination reactant or with the chlorination reactant comprises reacting used nuclear fuel with the fluorination reactant or with the chlorination reactant.

4. The method of claim 2, further comprising drying the feedstock comprising two or more actinide oxide compounds before reacting the feedstock with the fluorination reactant or with the chlorination reactant.

5. The method of claim 2, wherein reacting the feedstock comprising uranium dioxide (UO₂) and plutonium dioxide (PuO₂) comprises reacting the feedstock comprising UO₂ and PuO₂ at a UO₂:PuO₂ ratio of from about 25:77 to about 75:25 with the fluorination reactant or with the chlorination reactant.

6. The method of claim 1, wherein reacting the feedstock comprising two or more actinide oxide compounds with a fluorination reactant or with a chlorination reactant comprises:
forming the fluorinated actinide intermediate compounds comprising fully fluorinated actinide intermediate compounds, partially fluorinated actinide intermediate compounds, and non-fluorinated actinide intermediate compounds; or
forming the chlorinated actinide intermediate compounds comprising fully chlorinated actinide intermediate compounds, partially chlorinated actinide intermediate compounds, and non-chlorinated actinide intermediate compounds.

7. The method of claim 6, further comprising:
reacting one or more of the partially fluorinated actinide intermediate compounds and non-fluorinated actinide intermediate compounds with an additional amount of the fluorination reactant to form additional actinide fluoride compounds; or
reacting one or more of the partially chlorinated actinide intermediate compounds and non-chlorinated actinide intermediate compounds with an additional amount of the chlorination reactant to form additional actinide chloride compounds.

8. The method of claim 1, wherein reacting the feedstock comprising two or more actinide oxide compounds with a fluorination reactant or with a chlorination reactant comprises reacting ammonium bifluoride (NH₄HF₂), hydrogen fluoride (HF), sodium fluoride (NaF), an organic fluoride compound, chlorine gas (Cl₂), or a combination thereof with the two or more actinide oxide compounds.

9. The method of claim 8, further comprises adding hydrochloric acid (HCl) to the feedstock and the chlorine gas (Cl₂).

10. The method of claim 1, further comprising separating the actinide fluoride compounds or the actinide chloride compounds from the fluorinated actinide intermediate compounds or the chlorinated actinide intermediate compounds.

11. The method of claim 1, wherein oxidizing the fluorinated actinide intermediate compounds comprises exposing the fluorinated actinide intermediate compounds to oxygen (O₂), an alcohol, water (H₂O), or a combination thereof to form the actinide fluoride compounds.

12. The method of claim 11, further comprising heating the fluorinated actinide intermediate compounds.

13. The method of claim 1, wherein oxidizing the chlorinated actinide intermediate compounds to form actinide chlorides comprises exposing the chlorinated actinide intermediate compounds to a chlorinated carbon compound comprising carbon tetrachloride (CCl₄), trichloromethane (CHCl₃), an alcohol, other organic chloride, or a combination thereof.

14. The method of claim 1, wherein oxidizing the fluorinated actinide intermediate compounds or the chlorinated actinide intermediate compounds comprises forming the actinide fluoride compounds or the actinide chloride compounds at substantially the same U:Pu ratio as the U:Pu ratio of the feedstock.

15. The method of claim 1, wherein oxidizing the fluorinated actinide intermediate compounds or the chlorinated actinide intermediate compounds comprises forming the actinide fluoride compounds or the actinide chloride compounds at a purity of greater than about 95%.

16. A method of halogenating actinide oxide compounds, the method comprising:
reacting a feedstock comprising uranium oxide and plutonium oxide with a fluorination reactant or with a chlorination reactant to form:
fluorinated uranium intermediate compounds and fluorinated plutonium intermediate compounds, or
chlorinated uranium intermediate compounds and chlorinated plutonium intermediate compounds, respectively;
separating fully fluorinated intermediate compounds of the fluorinated uranium intermediate compounds and the fluorinated plutonium intermediate compounds from partially fluorinated intermediate compounds and non-fluorinated intermediate compounds of the fluorinated uranium intermediate compounds and the fluorinated plutonium intermediate compounds, or
separating fully chlorinated intermediate compounds of the chlorinated uranium intermediate compounds and the chlorinated plutonium intermediate compounds from partially chlorinated intermediate compounds and non-chlorinated intermediate compounds of the chlorinated uranium intermediate compounds and the chlorinated plutonium intermediate compounds;
oxidizing the fully fluorinated intermediate compounds or the fully chlorinated intermediate compounds to form uranium fluoride and plutonium fluoride or uranium chloride and plutonium chloride; and
recovering the uranium fluoride and plutonium fluoride or uranium chloride and plutonium chloride.

17. The method of claim 16, wherein the fluorinated uranium intermediate compounds comprise fully fluorinated uranium compounds, partially fluorinated uranium compounds and non-fluorinated uranium compounds and the fluorinated plutonium intermediate compounds comprise fully fluorinated plutonium compounds, partially fluorinated plutonium compounds and non-fluorinated plutonium compounds.

18. The method of claim 16, wherein the chlorinated uranium intermediate compounds comprise fully chlorinated uranium compounds, partially chlorinated uranium compounds and non-chlorinated uranium compounds and the chlorinated plutonium intermediate compounds comprise fully chlorinated plutonium compounds, partially chlorinated plutonium compounds, and non-chlorinated plutonium compounds.

19. A system for halogenating actinide oxide compounds, the system comprising:
a first reaction vessel configured to conduct a halogenation reaction of actinide oxide compounds;
a first separator coupled to the first reaction vessel and configured to separate halogenated actinide intermediate compounds from the actinide oxide compounds;
a second reaction vessel coupled to the first separator and configured to oxidize the halogenated actinide intermediate compounds to form halogenated actinide compounds; and
a second separator coupled to the second reaction vessel and configured to recover the halogenated actinide compounds.

20. The system of claim 19, further comprising one or more contactors configured to remove water from the actinide oxide compounds.
